(19) United States
(12) Patent Application Publication
(10) Pub. No.: US 2003/0133438 A1
(43) Pub. Date: Jul. 17, 2003

(54) Method and system for voice traffic concentration in an ATM/DSL head-end network

(76) Inventors: John William Richarson, Hamilton, NJ (US); Kumar Ramaswamy, Plainsboro, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/044,633

(22) Filed: Jan. 11, 2002

(51) Int. Cl. H04L 12/66; H04J 3/02

(52) U.S. Cl. 370/352; 370/537

(57) ABSTRACT

An asynchronous transfer mode (ATM) digital subscriber line (DSL) head-end network is disclosed which includes a network control system, which manages call traffic through the head-end network by assigning traffic to voice channels based on available time slots from a telephone company. A plurality of customer premise equipment (CPE) units provide customer line terminations with telephone service. The CPE units are coupled to a multiplexer. The network control system has an assignment mechanism which concentrates telecommunications traffic between the multiplexer and an asynchronous transfer mode (ATM) switch on the channels to compensate for a number of customer line terminations exceeding a number of voice channels on links to the telephone company.

### FIELD OF THE INVENTION

The present invention generally relates to network communications and, more particularly, to a method and system for voice traffic concentration in an asynchronous transfer mode (ATM) digital subscriber line (DSL) head-end network.

### BACKGROUND OF THE INVENTION

Asynchronous transfer mode/digital subscriber line (ATM/DSL) networks include equipment maintained at a central office, for example, switching equipment and multiplexing equipment. The ATM/DSL networks also include equipment maintained at a customer's location, for example, customer premise equipment (CPE).

Voice over digital subscriber line (VODSL) is a broadband service that complements digital subscriber line's (DSL's) data transport capabilities and permits for multiple voice lines and data to be simultaneously transmitted over a single existing copper wire pairs. Telephone companies provide fewer channels than the number of customers serviced by the channels.

In head-end digital subscriber line (DSL) networks, where digital data and voice transfer are employed, one-to-one correspondence between a number of customers and the number of available lines is maintained. This results in limiting the capacity of the head-end network. Further limitations are placed on DSL networks that employ asynchronous transfer mode (ATM) since telephone companies employ synchronous based networks, which are time slot based.

Franchised local telephone companies are classed as local exchange carriers (LECs). Competitive local exchange carriers (CLECs) are additional companies allowed to compete with the LECs. CLECs try to deliver service, which is priced below that of the dominant ILEC (Incumbent Local Exchange Carrier) to remain competitive, but also try to deliver service, which is superior in terms of value, customer responsiveness, and flexibility. Additional service features and incentives are often employed by CLECs to remain competitive with ILECs

CLECs purchase time slots from telephone companies to provide their customers with access to a telephone network. Typically, the customer has a business phone system (e.g., key system) hooked to the many central office (CO) lines. The ILEC charges for time slots for accessing the telephone network. The ILEC also provides for traffic concentration to reduce the number of dedicated circuits needed to service a given customer base. This concentration is typically implemented at the CO switch (e.g., 5ESS) and is operated by the ILEC.

Therefore, a need exists for a method and system for providing traffic concentration/aggregation at an asynchronous transfer mode (ATM)/ digital signal line (DSL) head-end network.

### SUMMARY OF THE INVENTION

An asynchronous transfer mode (ATM) digital subscriber line (DSL) head-end network is disclosed which includes a network control system, which manages call traffic through the head-end network by assigning traffic to voice channels based on available time slots from a telephone company. A plurality of customer premise equipment (CPE) units provide customer line terminations with telephone service. The CPE units are coupled to a multiplexer. The network control system has an assignment mechanism which concentrates telecommunications traffic between the multiplexer and an asynchronous transfer mode (ATM) switch on the channels to compensate for a number of customer line terminations exceeding a number of voice channels on links to the telephone company.

A method for concentrating traffic on a digital subscriber line (DSL) head-end network includes providing a plurality of customer premise equipment devices, which provide telephone interfaces to customer terminations and allocating timeslots from a telephone company for usage of a telephone network. The timeslots are managed by a network control system by employing channels to transmit and receive information through the head-end network. Telecommunications traffic is concentrated between the customer terminations and an asynchronous transfer mode (ATM) switch on the channels to compensate for a number of customer line terminations exceeding a number of available channels.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an exemplary head end network architecture showing some components employed in accordance with the present invention;

FIG. 2 is a flow/block diagram showing the concentration/aggregation of telecommunications traffic within a head-end network in accordance with the present invention;

FIG. 3 is a schematic diagram showing the concentration/aggregation of telecommunications traffic between a head-end network in accordance with the present invention and a telephone company.

It should be understood that the drawings are for purposes of illustrating the concepts of the invention and are not necessarily the only possible configuration for illustrating the invention.

### DETAILED DESCRIPTION OF THE INVENTION

The present invention includes a method and system, which provides traffic concentration at a head-end of an asynchronous (ATM) digital subscriber line (DSL) network. This aggregation may be in addition to any aggregation provided by a telephone company. By providing the aggregation/concentration function at the head-end network, competitive local exchange carriers (CLECs) may now offer customers this service directly. In so doing, the CLEC will be able to reduce the number of channels or time slots purchased or rented from the telephone company and reduce costs for customers. For example, instead of reserving 20 time slots from the telephone company, only 10 may be needed in accordance with the aggregation/concentration system of the present invention.

It should be understood that the elements shown in the figures may be implemented in various forms of hardware, software or combinations thereof. Preferably, these elements are implemented in hardware on one or more appropriately programmed general-purpose devices, which may include a processor, memory and input/output interfaces. Elements related to routing tables are implemented preferably implemented in software on one or more appropriately programmed general-purpose devices, which may also include a processor, memory and input/output interfaces.

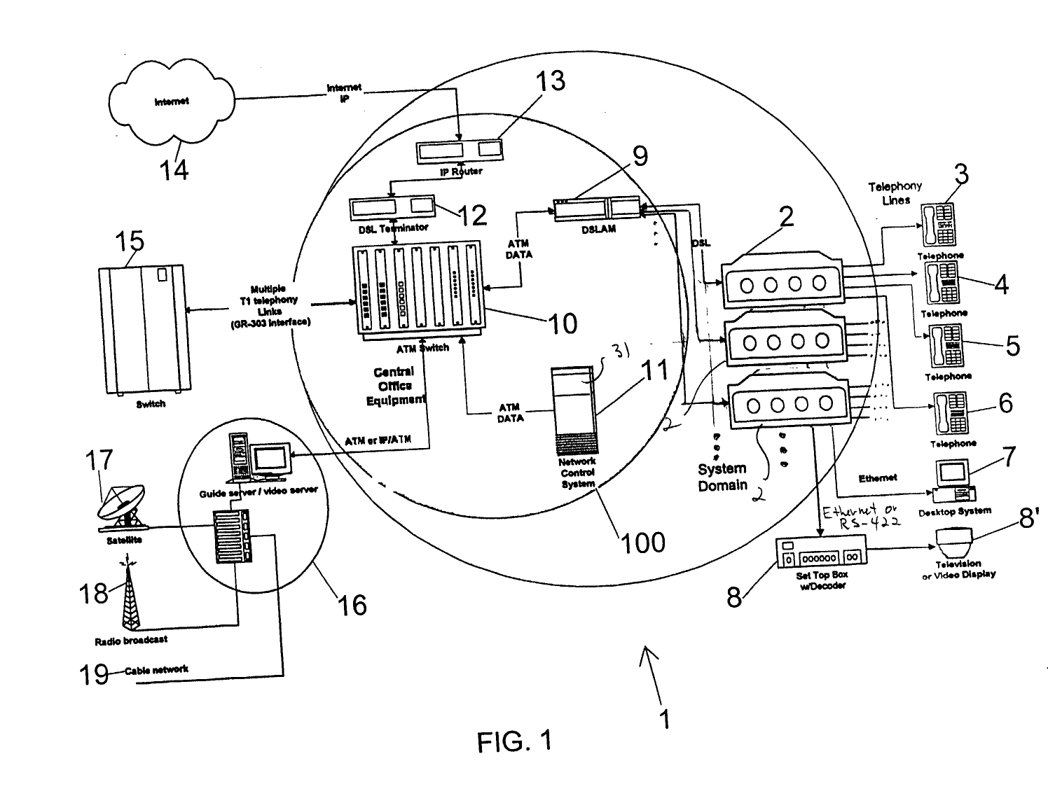

Referring now in specific detail to the drawings in which like reference numerals identify similar or identical elements throughout the several views, and initially to FIG. 1, a schematic block diagram of a digital subscriber line (DSL) head end network 1 is illustratively shown for integrating voice, data and/or video services. System architecture 1 is presented as an exemplary DSL environment for employing the inventive method and apparatus in accordance with the present invention. The system block diagram 1 is comprised of several functional blocks. The system domain is composed of Central Office (CO) Equipment 100 and Customer Premise Equipment (CPE). FIG. 1 is schematically shown and may include other equipment known to those skilled in the art. The component blocks within the system domain and their respective interfaces include: customer premise equipment (CPE) 2, Digital Subscriber Line Access Multiplexer (DSLAM) 9, an ATM switch 10, a public switched telephone network (PSTN) switch 15 and a network control system (NCS) 11.

One illustrative set-up for customer premise equipment (CPE) 2 includes, for example, a DSL modem unit (2) that interfaces with user devices, such as for example, analog telephones 3 employing, e.g., plain old telephone service (POTS), a 10Base-T Ethernet connection to a PC desktop system 7, and/or an Ethernet or RS-422 connection to a set-top box with a decoder 8′ for connection to, for example, a television or video display 8. From the customer's analog end, the CPE device 2 accepts the analog input from each of the telephones or devices 8 converts the analog input to digital data, and packages the data into ATM packets (POTS over ATM), with each connection having a unique virtual channel identifier/virtual path identifier (VCI/VPI).

An ATM is a connection-oriented protocol and as such there is a connection identifier in every cell header, which explicitly associates a cell with a given virtual channel on a physical link. The connection identifier includes two sub-fields, the virtual channel identifier (VCI) and the virtual path identifier (VPI). Together these identifiers are used for multiplexing, demultiplexing and switching a cell through the network. VCIs and VPls are not addresses, but are explicitly assigned at each segment link between ATM nodes of a connection when a connection is established, and remain for the duration of the connection. When using the VCI/VPI, the ATM layer can asynchronously interleave (multiplex) cells from multiple connections.

The Ethernet data is also encapsulated into ATM cells with a unique VPI/VCI. The ATM cell stream is sent to the DSL modem to be modulated and delivered to the DSLAM unit 9.

The DSL signal is received and demodulated by the DSL modem in the customer premise equipment 2 and delivered to VPI/VCI detection processing. The ATM cell data with VPI/VCI matching that of the end user's telephone is then extracted and converted to analog POTS to be delivered to the telephone. The ATM cell data with VPI/VCI matching that of the end user's Ethernet is extracted and delivered to an Ethernet transceiver for delivery to the port.

DSLAM 9 demodulates data from multiple DSL modems and concentrates the data onto the ATM backbone network for connection to the rest of the network. That DSLAM provides back-haul services for package, cell, and/or circuit based applications through concentration of the DSL lines onto ATM outputs to the ATM switch 10. The ATM switch 10 is the backbone of the ATM network. The ATM switch 10 performs various functions in the network, including cell transport, multiplexing and concentration, traffic control and ATM-layer management. Of particular interest in the system domain 100, the ATM switch 10 provides for the cell routing and buffering in connection to the DSLAM 9, network control system 11 and the Internet gateway connections, and T1 circuit emulation support in connection with the multiple telephony links switch 15. A T1 circuit provides, for example, 24 voice channels packed into a 193 bit frame transmitted at 8000 frames per second (DS1 links). The total bit rate is 1.544 Mbps. The unframed version, or payload, includes 192 bit frames for a total rate of 1.536 Mbps.

A GR-303 (FIG. 1) is an interface between a local digital switch (LDS) 10 and systems that provide network access to local loop telephone subscribers. These systems are called integrated loop carriers (IDLCs). The GR-303 defines Interface Groups (IG). The IGs can have up to 28 DS1 s, and have at least a minimum of 2 DS1 s. A traffic aggregation interface for up to 2048 subscribers is defined per GR-303 Interface Group. The primary DS1 on a GR-303 Interface Group carries two channels of control information on DS0 channels. Channel twelve and twenty-four are used for this purpose. Channel twelve is used for the timeslot management channel (TMC) and channel twenty-four is used for the embedded operations channel (EOC). Two other DS0s are also used for redundancy on the other DS1. The Timeslot Management Channel (TMC) is used for managing the timeslots (DS0s) on the DS1 links. For example, if an incoming call is detected by the telephone switch, it will signal this on the TMC channel and also indicate the DS0 that the incoming telephone call is on.

The data carried in the TMC indicates a Call Reference Value (CRV) that maps to a telephone number and also indicates the DS0 that has been allocated for the call. The Timeslot Management Channel (TMC) and the Embedded Operations Channel (EOC) will be setup on PVCs between the incoming DS1 links and NCS 11 used in the ATM/ADSL head-end system. There will be two TMC and EOC channels per defined GR-303 Interface Group (IG).

The ATM switch 10 may be coupled to a program guide server/video server 16 to satellite 17, radio broadcast 18 or cable 19 networks. The ATM switch 10 may also be coupled over a DSL terminator 12 and Internet protocol (IP) router 13 pair to receive Internet Protocol IP packet data from the Internet 14.

The network control system (NCS) 11 provides for address translation, demand assignment and call management functions. The network control system's principle function is to manage the DSL/ATM network including the origination and termination of phone calls, e.g., provisioning and routing calls. The NCS 11 is essentially the control entity communicating and translating control information between a class 5 PSTN switch 15 (using e.g., the SS7 or GR-303 protocols) and the CPE 2. The network control system 11 is available for other functions such as downloading code to the CPE, and bandwidth and call management functions, as well as other service provisioning and set up tasks.

In accordance with the present invention, ATM switch 10 manages channelized DS1 links, which are made available for customers for completing voice calls and data transfers through a telephone network. DS1 is a level in the digital hierarchy that transmits a multiplexed signal, which includes e.g., 24 DS0 channels (i.e., the basic channels in the digital hierarchy). DS1 links are provided to head-end network 1 as designated time slots for use in voice data transfer operations. Typically, head-end systems employ a one-to-one ratio of customer line terminations to voice channels on the DS1 links to the telephone company switch. In accordance with the present invention, more customer line terminations than the supply of voice channels on the DS1 links to the telephone company switch are provided. Advantageously, this can be performed by concentrating traffic in the ATM/DSL head-end network 1. Therefore, the traffic concentration may occur directly within head-end network 1. This permits local exchange carriers control over time slot allocation to a plurality of users. In addition, service providers controlling ATM/DSL head-end network 1, can provide more economical services to users by permitting users to subscribe to fewer time slots yet permit the same number of users (phone or computer stations) connected to the head-end network which employ phone service. Traffic concentration may also occur at the telephone company switch 15 as well as at the head-end network 1, thus providing two levels of traffic concentration/aggregation.

Traffic concentration can be managed locally through the ATM/DSL head-end network through NCS 11. NCS 11 controls demand assignment and call management including the origination and termination of phone calls, e.g., provisioning and routing calls. NCS 11 requests timeslots or channels from the telephone company's network system. These timeslots are made available to subscribers or users of the head-end network 1. The available timeslots are provisioned on a first-in first-out (FIFO) basis or by other priority methods. The voice traffic concentration management is implemented by using a demand assignment function in NCS 11. This assignment function assigns a free channel to an incoming or outgoing voice call based on demand or request. By having this functionality, it serves the purpose of traffic concentration locally to the ATM/DSL head-end network 1 and allows the over-subscription of available channels in the DS1 links to customer line terminations.

NCS 11 sets up and breaks down virtual circuits through the DSL head-end network 1. This provides an end-to-end virtual circuit from the GR303 interface to the CPE 2 An assignment mechanism 31 is stored preferably as a software program in NCS 11. Mechanism 31 assigns traffic requests and demands in accordance with the available timeslots rented from the telephone company. With the local control provided by NCS 11 over-subscription of the available timeslots (channels) is permitted. With this functionality, NCS 11 can concentrate caller activity on available timeslots (channels) through the head-end network 1. The ability to concentrate/aggregate call traffic permits a local service provider (e.g., CLEC) more control over head-end network usage and provides more service options to subscribers. When timeslots are unavailable, the customer will not receive dial tone and will hear silence or, as an alternative, a local busy signal can be generated at CPE 2.

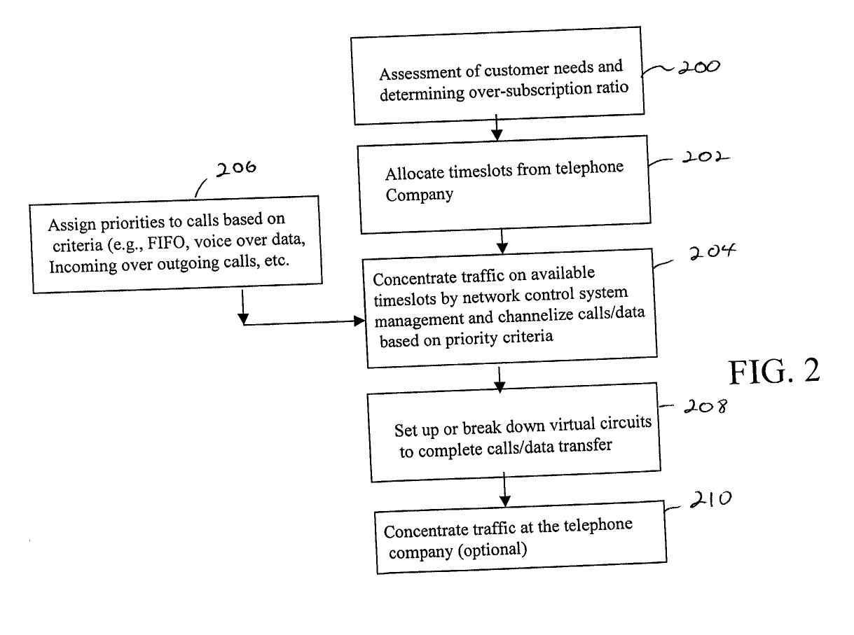

Referring to FIG. 2 with continued reference to FIG. 1, a block diagram showing the provisioning of timeslots, made available for usage by head-end network 1, by a telephone company is illustratively shown. In block 200, an assessment of customer phone usage is made to determine a number of time slots or channels, which are needed to accommodate the needs of a subscriber(s) to DSL or VoDSL service through head-end network 1. This includes determining an over-subscription ratio, which reduces the number of timeslots rented from the telephone company, preferably without reducing service access to the customer lines.

In block 202, time slots are allocated to a head-end network by subscription to a telephone company, which controls the usage of the telephone network. The timeslots are allocated among channels by NCS 11 on DS1 links to the telephone switch 15. Advantageously in accordance with the present invention, the number t of available voice channels on the DS1 links is exceeded by the number of customer lines being serviced at the head-end network 1. The ratio of subscriber lines to available voice channels is greater than 1, and preferably greater than 2. In other embodiments, larger ratios may exist, depending on the type of application and/or the system usage for a particular system.

In block 204, management of the available time slots by NCS 11 provides traffic concentration of customer lines. When a user needs to make or receive a call, NCS 11 assigns that customer line a channel which is employed to place or receive a call over the telephone network. The channel is preferably assigned based on its priority. Priorities are assigned in block 206. For example, incoming calls may have a higher priority than outgoing calls, or certain numbers of customer lines may have a higher priority than other customer lines, or voice calls have a priority over data transmissions. Other channel assignment schemes include assigning channels on a first-come first-served basis. The weights and priorities for different scenarios are stored in the memory of NCS 11 so that the assignment of available channels is appropriately performed. The available channels on head-end network 1 are over-subscribed. Over-subscription means that the number of channels available is less than the number of customer lines serviced by the head-end network 1.

In block 208, NCS 11 sets up or breaks down virtual circuits through the head-end network 1. The virtual circuits between DSLAM 9 and ATM switch 10 are created to permit the appropriate asynchronous transfer of voice and/or data through the head-end network 1 to/from the telephone network.

In block 210, traffic concentration may be performed by the telephone company as well. Traffic concentration performed by the telephone company is provided in addition to the traffic concentration/aggregation at the head-end network 1. Traffic concentration at the head-end network 1 is preferably provided by a competitive local exchange carrier (CLEC) to its customers. In this way, the service provided by the CLEC to the DSL line subscribers is customized to the customers needs. A customer no longer needs to support a one-to-one ratio of voice channels on DS1 links to customer line terminations. This results in savings for the customer since timeslot rental from the telephone company is reduced.

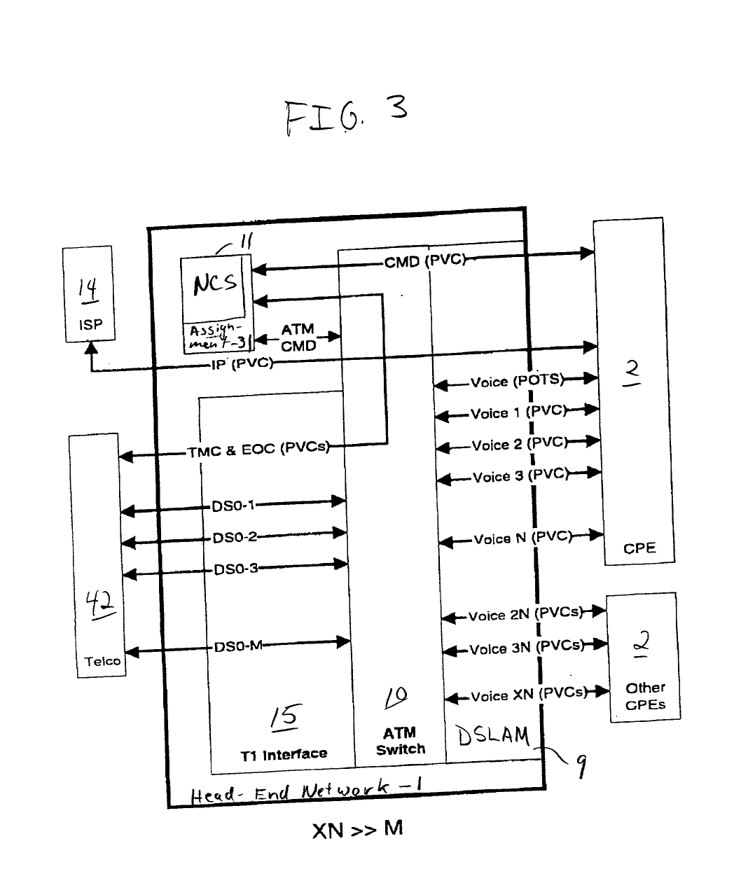

Referring to FIG. 3, a schematic diagram illustrates the concentration/aggregation at a head-end network in accordance with the present invention. The number of voice channels XN available from a plurality of CPEs 2 exceeds the number of DS0 channels M available from the telephone company 42 (e.g., XN>>M). By employing DSLAM 9, ATM switch 10, which are controlled by NCS 11, aggregation of calls is performed at the head-end network 1. NCS 11 is also responsible for setting up permanent virtual circuits (PVCs) through the head-end network 1. NCS 11 provides control of ATM switch 10, DSLAM 9 and CPE 2 through a command (CMD) PVC. NCS 11 further sets up and routes ATM cells (ATTM CMD). Internet service provider (ISP) 14 interfaces through head-end network 1 using Internet protocol (IP). TMC and EOC PVCS are provided between NCS 11 and the telephone company 42.

ATM cells sent through network 1 include voice data from a plurality of voice channels. However, in accordance with the present invention the available DS0 channels are used more efficiently since NCS 11 allocates the voice data into DS0 channels in accordance with call priority at the head-end network 1 itself.

Having described preferred embodiments for methods and systems for voice traffic concentration in an ATM/DSL head-end network (which are intended to be illustrative and not limiting), it is noted that (modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. An asynchronous transfer mode (ATM) digital subscriber line (DSL) head-end network; comprising:
a network control system, which manages call traffic through the head-end network by assigning traffic to voice channels based on available time slots from a telephone company;
a plurality of customer premise equipment (CPE) units which provide customer line terminations with telephone service, the CPE units being coupled to an ATM multiplexer;
the network control system having an assignment mechanism which concentrates telecommunications traffic between the multiplexer and an asynchronous transfer mode (ATM) switch on the channels to compensate for a number of customer line terminations exceeding a number of voice channels.

2. The network as recited in claim 1, wherein the assignment mechanism allocates voice channels in accordance with a priority of a call.

3. The network as recited in claim 1, wherein the number of customer line terminations exceeds the number of voice channels by greater than 2.

4. The network as recited in claim 1, wherein the voice channels are included on digital signal 1 (DS1) links to a telephone company switch.

5. The network as recited in claim 1, wherein the telecommunications traffic includes voice and data transfer.

6. The network as recited in claim 1, wherein the assignment mechanism is embodied in a software application stored on the network control system.

7. A method for concentrating traffic on a digital subscriber line (DSL) head-end network, comprising the steps of:
providing a plurality of customer premise equipment devices, which provide telephone interfaces to customer terminations;
allocating timeslots from a telephone company for usage of a telephone network;
managing the timeslots using a network control system by employing channels to transmit and receive information through the head-end network; and
concentrating telecommunications traffic between the customer terminations and an asynchronous transfer mode (ATM) switch on the channels to compensate for a number of customer line terminations exceeding a number of available channels.

8. The method as recited in claim 7, wherein the step of concentrating telecommunications traffic includes the steps of:
evaluating demand on the head-end network; and
determining a ratio between the number of customer line terminations to number of available channels based on the demand.

9. The method as recited in claim 8, wherein the ratio is greater than two.

10. The method as recited in claim 8, wherein the ratio is greater than ten.

11. The method as recited in claim 7, further comprising the step of additionally concentrating traffic by the telephone company.

12. The method as recited in claim 7, wherein the step of managing the timeslots includes the step of assigning incoming and outgoing calls to the channels in accordance with a priority criterion.

13. The method as recited in claim 12, wherein the priority criterion includes first-in first-out criterion.

14. The method as recited in claim 12, wherein the priority criterion includes priority of incoming calls over outgoing calls.

15. The method as recited in claim 12, wherein the priority criterion includes priority of voice over data.

16. The method as recited in claim 7, further comprising the step of establishing virtual circuits through the head-end network to make connects between the telephone company and the customer premise equipment devices.
